(19) United States
(12) Patent Application Publication
(10) Pub. No.: US 2009/0256823 A1
(43) Pub. Date: Oct. 15, 2009

(54) Display Device and Transparent Magnetic Film

(75) Inventors: Hiroyuki Fujita, Tokyo (JP); Hiroshi Toshiyoshi, Tokyo (JP); Akio Higo, Tokyo (JP); Roi Shigematsu, Tokyo (JP)

Correspondence Address: KENYON & KENYON LLP, ONE BROADWAY, NEW YORK, NY, 10004, US

(73) Assignee: TOKYO, THE UNIVERSITY OF, Bunkyo-ku, Tokyo (JP)

(21) Appl. No.: 12/085,802

(22) PCT Filed: Nov. 28, 2006
(86) PCT No.: PCT/JP2006/323743

§ 371 Date: May 29, 2008

(30) Foreign Application Priority Data
Dec. 2, 2005 (JP) 2005-349290

(51) Int. Cl. G06F 3/042; B32B 27/36; B32B 9/00; B32B 27/18

(52) U.S. Cl. 345/176; 428/480; 428/692.1; 428/447

(57) ABSTRACT

A display device is provided with an optical waveguide, a transparent fixed electrode disposed in surface contact with the optical waveguide, and a transparent movable electrode disposed facing the transparent fixed electrode on a side opposite to the optical waveguide. When a driving voltage is applied, the transparent movable electrode is movable by an external force, between a first stable state in which it is kept apart from the transparent fixed electrode by elasticity, and a second stable state in which it makes insulated contact with the transparent fixed electrode by electrostatic force.

There is no concern about contaminating the air or dirtying hands, and it is possible to write easily using a finger or a simple writing tool, and repeatedly erase.

### TECHNICAL FIELD

The present invention relates to a display device, which is provided with a movable electrode, a fixed electrode, and an optical waveguide. Furthermore, the present invention relates to a transparent magnetic film that is ideally suited for use as the movable electrode.

Priority is claimed on Japanese Patent Application No. 2005-349290, filed Dec. 2, 2005, the content of which is incorporated herein by reference.

### BACKGROUND ART

Heretofore, blackboards and whiteboards have been employed as communication tools all over the world, such as in classrooms, offices, and the like. Even now with the progress of industrialization, they still retain their primitive forms. However, with a conventional blackboard and whiteboard, when a user erases letters written by chalk or the like, it takes time, which is a bottleneck that reduces the efficiency of a meeting or a class.

Therefore, a range of so-called electronic blackboards has been proposed. For example: an electronic blackboard, in which felt pen hand writing can be read using a scanner to turn it into electronic data; a type of electronic blackboard, being a large area device that can be erased by the physical movement of a bar; and the like, have been proposed. Moreover, a simple board for user input and an input type liquid crystal device have also been developed.

Furthermore, a range of applications of micro electro mechanical systems (MEMS) to display devices has been proposed. For example, in non-patent document 1, an electrostatically driven optical display device, using the evanescent coupling between a sheet waveguide and multi-cantilevers is proposed.

[Non Patent Document 1] Oguchi Toshiaki and three others, “An Electrostatically Driven Display Device Using Evanescent Coupling Between a Sheet Waveguide and Multi-cantilevers”, Transactions of the Institute of Electrical Engineers of Japan E, 2004, Vol. 124, No. 3, pp. 87-92.

### DISCLOSURE OF INVENTION

### Problems that the Invention is to Solve

However, the product normally called an electronic blackboard has a construction in which magnetic sand is attracted by magnetic force, and its resolution is poor. There is no blackboard type display device in which all images and characters can be erased by one button. Moreover, although simple user input type boards and input type liquid crystal device have high accuracy, there are problems of high cost and small area.

Furthermore, many of the proposed applications of MEMS to display devices are ones that have complicated wiring layouts and processing in a central processing unit (CPU) for display on a liquid crystal device or the like on the other side, such as a touch panel, or display on a display device separated from the input device. Moreover, these have substrates that require resist patterning or etching, and hence there is an obstacle from the point of view of manufacturing cost in order for them to be substituted for widely used blackboards. Furthermore, in many cases, thin line parts of less than 20 μm in width are required. Hence in many cases there is poor compatibility with large area printing techniques such as roll to roll printing, ink jet printing, silk screen printing, offset printing and the like, and plastic molding techniques, stamping techniques and the like.

Therefore, an object of the present invention is to provide a display device with which there is no concern about contaminating the air or dirtying hands, it is possible to write easily using a finger or a simple writing tool, erase instantly, and repeatedly write and erase freely, and that has appropriate resolution, and can be manufactured with a large area inexpensively. Furthermore, it provides a transparent magnetic film that is ideally suited for use as the movable electrode of the display device.

### Means of Solving the Problems

The present inventors discovered, as a result of keen examination, that a display device can be written on and erased easily using a simple structure constructed such that a movable electrode can change, by applying external force, from one stable state, in which it is kept apart from a transparent fixed electrode by elasticity, to another stable state, in which it makes insulated contact with the transparent fixed electrode by electrostatic force. Furthermore, they discovered a transparent magnetic film ideally suited for this transparent movable electrode.

A display device of the present invention is characterized in that it is provided with an optical waveguide, a transparent fixed electrode disposed in surface contact with the optical waveguide, and a transparent movable electrode disposed facing the transparent fixed electrode on a side opposite to the optical waveguide, and wherein when a driving voltage is applied, the transparent movable electrode has a first stable state in which it is kept apart from the transparent fixed electrode by elasticity, and a second stable state in which it makes insulated contact with the transparent fixed electrode by electrostatic force, and can change from the first stable state to the second stable state by external force.

The construction of the display device of the present invention may be such that the transparent movable electrode can be restored from the second stable state to the first stable state by removing the driving voltage. The construction of the display device of the present invention may be such that the transparent movable electrode can be restored from the second stable state to the first stable state by an external magnetic force.

It is preferable to use a conductive transparent magnetic film for the transparent movable electrode, and the transparent magnetic film can be formed from a transparent insulator layer, a transparent conductor layer, and a transparent magnetic layer formed from transparent elastic material in which granular magnetic material is dispersed, arranged in a stack. It is preferable to provide spacers disposed between the transparent movable electrode and the transparent fixed electrode, and to apply metallic color treatment or deep color treatment to the transparent fixed electrode side of the spacers.

Furthermore, the transparent magnetic film of the present invention is characterized in that it comprises a transparent insulator layer, a transparent conductor layer, and a transparent magnetic layer formed from transparent elastic material in which granular magnetic material is dispersed, arranged in a stack. For the transparent insulator layer, polyethylene naphthalate (PEN) can be used, and for the transparent conductor layer, indium oxide-stannic oxide (ITO) thin film can be used, and the transparent magnetic layer can be formed by dispersing nickel particles in transparent elastic material formed from polydimethylsiloxane (PDMS).

### EFFECTS OF THE INVENTION

The display device of the present invention is provided with an optical waveguide, a transparent fixed electrode disposed in surface contact with the optical waveguide, and a transparent movable electrode provided facing the transparent fixed electrode on the side opposite to the optical waveguide, wherein when a driving voltage is applied, the transparent movable electrode has one stable state in which it is kept apart from the transparent fixed electrode by elasticity, and another stable state in which it makes insulated contact with the transparent fixed electrode by electrostatic force, and can change from one stable state to the other stable state by external force. Thus, it is possible to provide a new type of rewritable electronic blackboard with adequate resolution and low cost that can be manufactured with a large area, wherein there is no concern about contaminating the air or dirtying hands, it is possible to write images and letters easily by applying an external force such as the pressure of a finger or a simple writing tool, to display letters and to erase them, and writing and erasing can be repeated freely. The present invention can be applied to a blackboard type device that can display images and letters drawn directly on the surface by the pressure of a finger or a simple pen point. Moreover, unlike a touch panel used for a PDA or the like, the display device of the present invention can be manufactured using a very thin and light structure, and there is no such limitation in size as there is in the manufacturing method of a liquid crystal display used for a touch panel.

Furthermore, since the transparent magnetic film of the present invention comprises; the transparent insulator layer, the transparent conductor layer, and the transparent magnetic layer formed from the transparent elastic material in which granular magnetic material is dispersed, arranged in a stack, it is conductive, transparent, and has excellent magnetic properties. The transparent magnetic film of the present invention is ideally suited for use as the movable electrode of the display device of the present invention.

### BRIEF DESCRIPTION OF THE DRAWINGS

FIG. 1A is a schematic diagram showing a display device 100 of the present invention. FIG. 1B is a conceptual diagram showing an equivalent circuit of the display device 100 shown in FIG. 1A.

FIG. 2 is a conceptual diagram showing the relationship between electrostatic force and spring restoring force.

FIG. 3 is a conceptual diagram showing the hysteresis behavior of the displacement of a movable electrode 1 in the display device 100.

FIG. 4 is a conceptual diagram to explain the principle of the operation of the display device 100 of the present invention.

FIG. 5A is a cross-sectional conceptual diagram of the transparent magnetic film 10 of the present invention, which is ideally suited for use as the transparent movable electrode of the display device 100. FIG. 5B shows photographs showing the excellent transparency and magnetism of the transparent magnetic layer 15 of the transparent magnetic film 10 of the present invention.

FIG. 6 is a conceptual diagram showing light scattering in spacers 4.

FIG. 7A is a conceptual diagram showing the prevention of light scattering in the spacers 4. FIG. 7B shows photographs showing the effect of preventing light scattering in the spacers 4.

FIG. 8 is a conceptual diagram showing an example of a manufacturing process of the display device 100 of the present invention.

FIG. 9 is a conceptual diagram showing an example of a manufacturing process of the display device 100 of the present invention.

FIG. 10 is a schematic diagram showing an example of the display device 100 of the present invention.

FIG. 11 is a schematic diagram showing an example of the display device 100 of the present invention.

FIG. 12 contains conceptual diagrams and photographs, which show an example of the operation of the display device 100 of the present invention.

FIG. 13 is a photograph showing an example of the successful writing of the letter “P” using the display device of the present invention.

FIGS. 14A, B, C, D and E are photographs of examples of the operations of an initial state B, writing C, partial erase D, and simultaneous erase E of the display device 100 of the present invention A, taken in a bright room.

FIG. 15 is a conceptual diagram showing an example of colorization of the display device 100 of the present invention.

FIG. 16 is a conceptual diagram showing an example of colorization of the display device 100 of the present invention.

FIG. 17 is a conceptual diagram showing an example of colorization of the display device 100 of the present invention.

FIG. 18 is a conceptual diagram showing an example of colorization of the display device 100 of the present invention.

FIG. 19 is a conceptual diagram showing an example of colorization of the display device 100 of the present invention.

FIG. 20 is a conceptual diagram showing an example of colorization of the display device 100 of the present invention.

FIG. 21 is a conceptual diagram showing an example of a measure for preventing electric shocks to fingers in a display device 101 of the present invention.

FIG. 22 is a conceptual diagram showing an example of a measure for improving the durability of a transparent movable electrode 1 in the display device 100 of the present invention.

FIG. 23 shows photographs of an example of simultaneous erase in the display device 100 of the present invention.

FIG. 24 shows photographs of an example of partial erase in the display device 100 of the present invention.

FIG. 25 is a photograph showing the setup of the display device 100 of the present invention.

FIG. 26 is an example of a conceptual diagram and photographs, which show a principle for brightening pixels in the display device 100 of the present invention.

FIGS. 27A, B, C and D show the operation of the display device 100 of the present invention. A is a photograph showing an initial state, B is a photograph showing a state of writing by pressing with a finger, C is a photograph showing a state in which the movable electrode 1 is pulled outwards and partially erased by tracing a magnet over it, and D is a photograph showing the off (dark) state when the driving voltage is turned off.

FIG. 28 shows enlargements of the photographs in FIG. 26.

### DESCRIPTION OF THE REFERENCE SYMBOLS

1: Transparent Movable Electrode
1a: Transparent Magnetic Layer
1b: Transparent Conductor Layer
1c: Transparent Insulator Layer
1d: Transparent Conductor Layer
2: Optical Waveguide
3: Transparent Fixed Electrode
4: Spacer
5: Power Supply
7: Durability Protecting Film
10: Transparent Magnetic Film
11: Transparent Insulator Layer
12: Transparent Conductor Layer
13: Transparent Elastic Material
14: Granular Magnetic Material
15: Transparent Magnetic Layer
20: Display Device
100: Display Device
101: Display Device

### BEST MODE FOR CARRYING OUT THE INVENTION

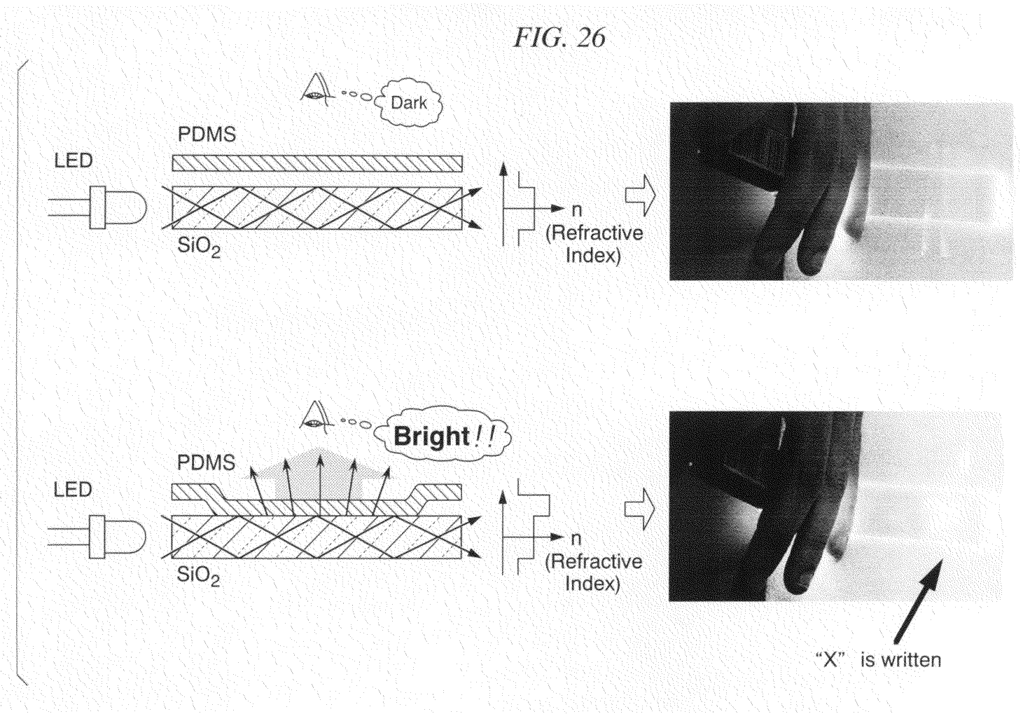

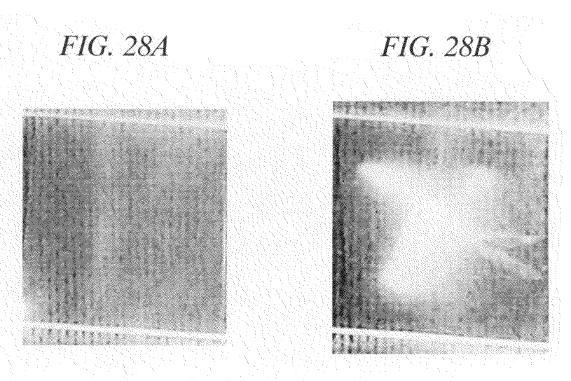

The display device 100 of the present invention is provided with an optical waveguide 2, a transparent fixed electrode 3 disposed in surface contact with the optical waveguide 2, and a transparent movable electrode 1 disposed facing the transparent fixed electrode 3 on the side opposite to the optical waveguide 2. Firstly, a principle for brightening pixels in the display device 100 of the present invention will be described using the conceptual diagram of FIG. 26. In the display device of FIG. 26, LED light is radiated from one end of a glass substrate (SiO₂), being the optical waveguide 2, and the LED light is totally reflected repeatedly in the glass substrate, so that the light does not leak outside. The most desirable angle of the incident light relative to the glass substrate, for the condition of total reflection, is approximately 45 degrees. However, when a substance (for example, PDMS) whose refractive index is higher than air, which disturbs the total reflection, makes contact with the surface of the optical waveguide 2 when totally reflecting, part of the light enters the side of the substance, and in the case where there is any scattering source inside of the substance, the reflections are irregular, and the light becomes visible. For example, as in the right-hand side (enlarged photograph: FIG. 28) of FIG. 26, it is possible to write a letter “X”.

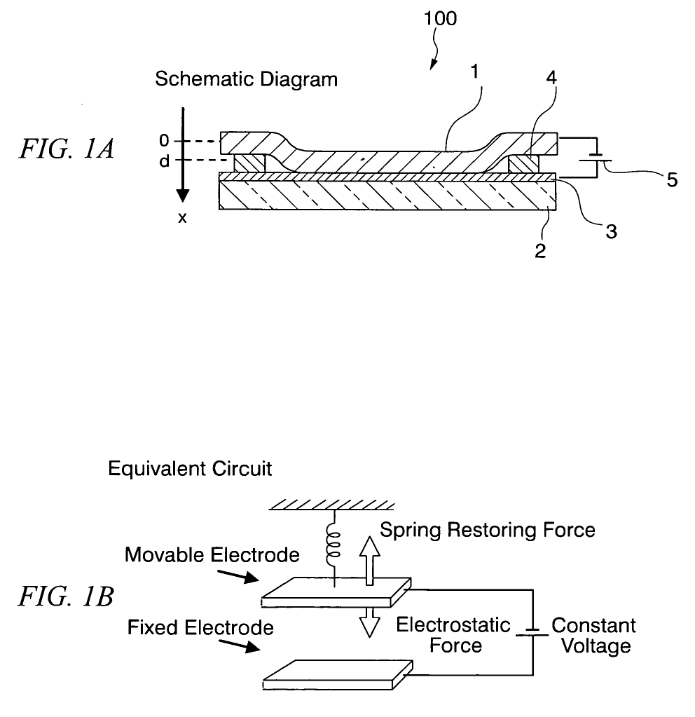

The display device of the present invention will be described using drawings. FIG. 1A is a schematic diagram of a display device 100 of the present invention. The display device 100 of FIG. 1A is provided with an optical waveguide 2, a transparent fixed electrode 3 disposed in surface contact with the optical waveguide 2, a transparent movable electrode 1 disposed facing the transparent fixed electrode 3 on the side opposite to the optical waveguide 2, a power supply 5, which supplies a driving voltage between the transparent movable electrode 1 and the transparent fixed electrode 3, and spacers 4 disposed between the transparent movable electrode 1 and the transparent fixed electrode 3.

Furthermore, the display device of the present invention can be simplified to a model of a parallel plane type capacitor. FIG. 1B is an equivalent circuit of the display device 100 shown in FIG. 1A. In this model, when a driving voltage is applied, a predetermined driving voltage can be established such that the movable electrode 1 has two stable points (stable states, State-1 and State-2).

From the fact that the movable electrode is “movable”, it is possible to assume a case wherein the construction is such that its position can be moved relative to the fixed electrode by the spring restoring force of another material, or a case wherein the construction is such that the movable electrode itself has a spring restoring force, and can be deformed.

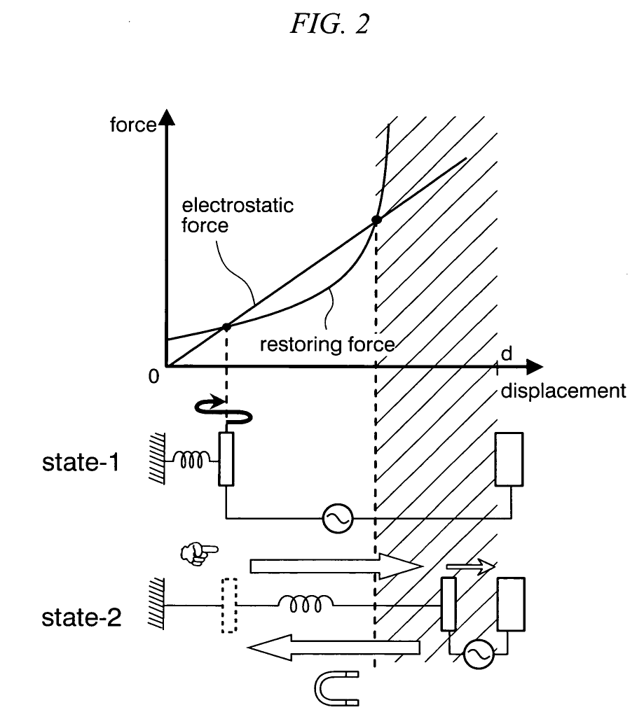

The relationship between the electrostatic force and the spring restoring force of this model is shown in FIG. 2. In the vicinity of “State-1”, since the movable electrode 1 performs simple harmonic motion around the stable point, even if a small amount of displacement occurs in the movable electrode 1, it does not make contact with the fixed electrode 3. “State-1” is a state in which the electrostatic force and the spring restoring force are equal, and is a stable state in which the transparent movable electrode 1 is separated from the transparent fixed electrode 3 by elasticity in the display device 100 of the present invention. Since the transparent movable electrode 1 is separated from the transparent fixed electrode 3, the display device 100 is in an off (dark) state.

However, in the case where the displacement of the movable electrode 1 is sufficiently large, as in “State-2” of FIG. 2, the electrostatic force is greater than the spring restoring force, so the movable electrode 1 makes contact with the fixed electrode 3. “State-2” is a stable state in which it makes insulated contact with the transparent fixed electrode 3 by electrostatic force in the display device 100 of the present invention. Since the transparent movable electrode 1 is in contact with the transparent fixed electrode 3, the display device turns to an on (bright) state.

Moreover, during the displacement of the movable electrode 1, there is another point at which the electrostatic force and the spring restoring force are in equilibrium, other than the above-described “State-1”. When the movable electrode 1 is on the “State-1” side of this boundary point, the movable electrode 1 tries to be stable at “State-1”. Furthermore, when the movable electrode 1 is on the “State-2” side (hatched part of FIG. 2), the movable electrode 1 tries to be stable at “State-2”.

By this principle, in the display device 100 of the present invention, it is possible to have the movable electrode 1 move back and forth between “State-1” and “State-2” by an external force such as; the pressure of a finger or a simple writing tool, the adhesive power of a pressure sensitive adhesive roller, or an electromagnetic force. By so doing, writing and partial erasing can be realized. It is possible to separate the movable electrode 1 using a magnetic force by applying a magnetic layer to the movable electrode 1, and thus partial erasing by a magnet can be realized. Furthermore, the display device 100 of the present invention can be applied to a display device 100 in which a stable state of the movable electrode 1, which is held by static electricity, is changed physically by an external force, and thus retains color.

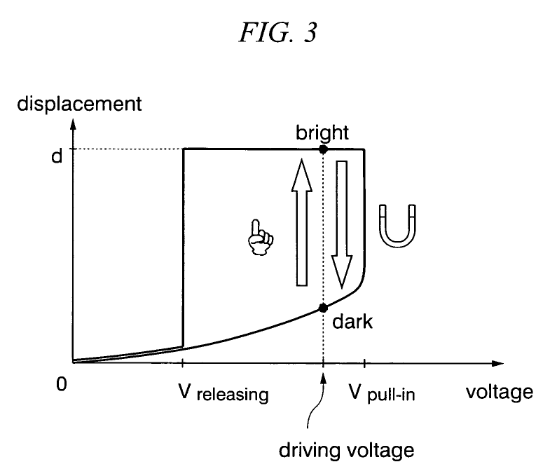

Here, the driving voltage can be determined by the hysteresis graph of FIG. 3. In the graph of FIG. 3, the horizontal axis represents the potential difference (V) between the movable electrode 1 and the fixed electrode 3, and the vertical axis represents the displacement (d) from a stable position (0) of the movable electrode 1 when the voltage is zero, and the movable electrode 1 receives no external force. When a voltage is applied gradually between the movable electrode 1 and the fixed electrode 3, as is shown by the solid line of FIG. 3, the movable electrode 1 is gradually drawn toward the fixed electrode side from the stable position (0). Here, since the spring restoring force is not affected by the potential difference, it becomes greater in a straight line relative to the displacement, as in FIG. 2. The electrostatic force is equal to the spring restoring force (“State-1” of FIG. 2). At this time, the display device 100 is in an off (dark) state. However, when the potential difference reaches a pull-in voltage (Vₚᵤₗₗ₋ᵢₙ), the two points at which the electrostatic force and the spring restoring force are in equilibrium become one point as in FIG. 2, and furthermore, when the potential difference is increased, the electrostatic force becomes greater than the spring restoring force, and the movable electrode 1 is displaced immediately, until it makes contact with the fixed electrode 3. Next, when the potential difference is reduced gradually, the movable electrode 1 remains in contact with the fixed electrode 3 for a while. However, when it reduces to a releasing voltage (V_{releasing}), the movable electrode 1 separates immediately, and restores to “State-1” due to the spring restoring force.

The solid line of FIG. 3 shows the hysteresis behavior. By setting the driving voltage between the releasing voltage (V_{releasing}) and the pull-in voltage (Vₚᵤₗₗ₋ᵢₙ), it is possible to change from one stable state (off (dark) state) to the other stable state (on (bright) state) by external force, so that the display device 100 of the present invention can be realized. In order to make the contact between the two electrodes of the transparent fixed electrode 3 and the transparent movable electrode 1 stronger to increase the contact area, it is necessary for the driving voltage to be close to the pull-in voltage. On the other hand, the driving voltage can be reduced to the release voltage.

In this manner, it is possible to determine the desirable driving voltage for a particular display device. However, this is influenced by the pixel size of the display device, the distance between the two electrodes, the elastic properties of the movable electrode, and the like. Furthermore, each individual pixel can be easily influenced, especially by the dispersion in the distance between the two electrodes. Therefore, it is important to make the height of the spacers, which determines the distance between the two electrodes, uniform. Moreover, if the difference between the releasing voltage (V_{releasing}) and the pull-in voltage (Vₚᵤₗₗ₋ᵢₙ) is small, stable operation is difficult. Therefore, it is important for the design to balance; the pixel size of the display device, the distance between the two electrodes, and the elastic properties of the movable electrode.

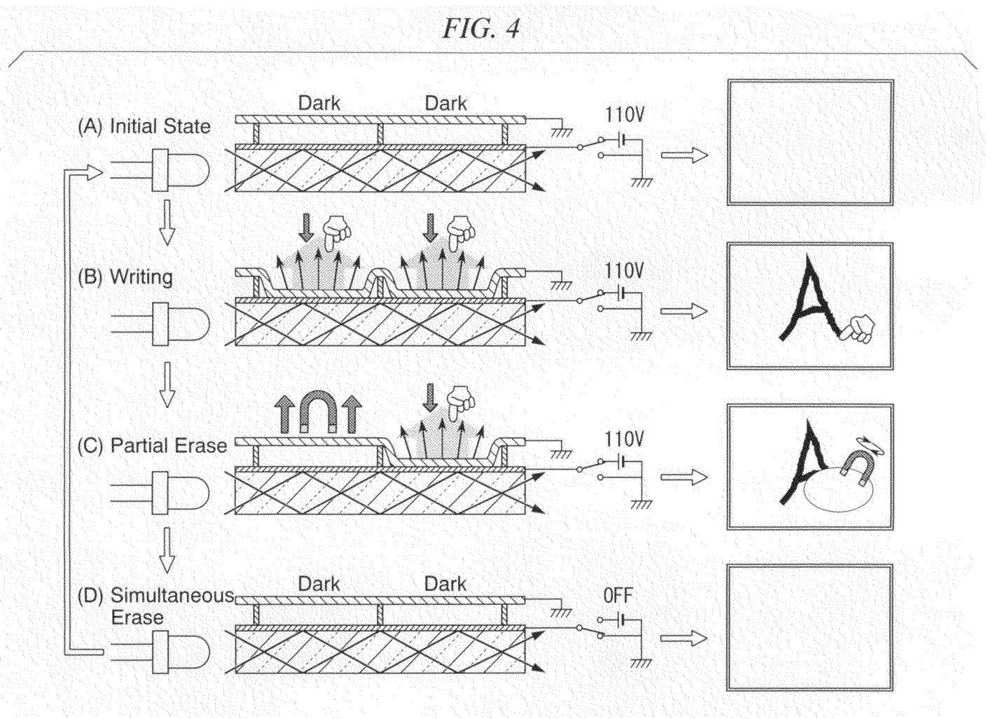

The principle of operation of a display device 100 that is applicable to a blackboard type rewritable display and the like, which is an example of the display device 100 of the present invention, will be described using FIG. 4. The display device 100 is provided with an optical waveguide 2, a transparent fixed electrode 3 disposed in surface contact with the optical waveguide 2, a transparent movable electrode 1 disposed facing the transparent fixed electrode 3 on the side opposite to the optical waveguide 2, a power supply 5, which supplies a driving voltage between the transparent movable electrode 1 and the transparent fixed electrode 3, and spacers 4 disposed between the transparent movable electrode 1 and the transparent fixed electrode 3. The construction is such that the transparent movable electrode 1, the transparent fixed electrode 3, and the spacers 4, constitute a plurality of pixels, and when a driving voltage is applied, the movable electrode part 1 of each pixel has one stable state in which it is kept apart from the transparent fixed electrode by elasticity, and another stable state in which it makes insulated contact with the transparent fixed electrode by electrostatic force, and external force can change it from one stable state to the other stable state independently.

A constant voltage is applied between the film (transparent movable electrode 1) and the substrate (transparent fixed electrode 3). However, the voltage is not great enough to make the movable electrode part 1 of each pixel contact the transparent fixed electrode 3 by electrostatic force. This film is conductive, and is a transparent magnetic film, which is attracted by a magnetic force. By removing the driving voltage, the movable electrode part 1 of each pixel can be restored from the second stable state (on (bright) state) to the first stable state (off (dark) state) simultaneously. Moreover the transparent movable electrode 1 can be restored from the second stable state (on (bright) state) to the first stable state (off (dark) state) by an external magnetic force. In this initial state, the electrostatic force applied to the film and the restoring force of the film as a spring are balanced (FIG. 4A). However, when the film receives a physical force by a finger or the like, and is pressed (written) to the substrate side, the static electricity increases rapidly to become greater than the spring restoring force due to its close proximity to the substrate. As a result, the film makes contact with the substrate, is pulled-in, and the light is dispersed (FIG. 4B). In this manner, writing by a finger or a simple writing tool can be realized. The device has two types of erasing method (methods of releasing the contact between the two electrodes). FIG. 4C shows an operation of partially pulling the film apart from the substrate by tracing a magnet over it, for example. On the other hand, FIG. 4D shows a simultaneous erase by removing the voltage. In the display device 100, writing, partial erase, and simultaneous erase, are realized by the above-described four states. The display device 100 of the present invention can be applied to an electronic blackboard that can partially erase retained color by using a magnet. Furthermore, the display device 100 of the present invention can be applied to an electronic blackboard that can erase the retained colors simultaneously by removing the voltage.

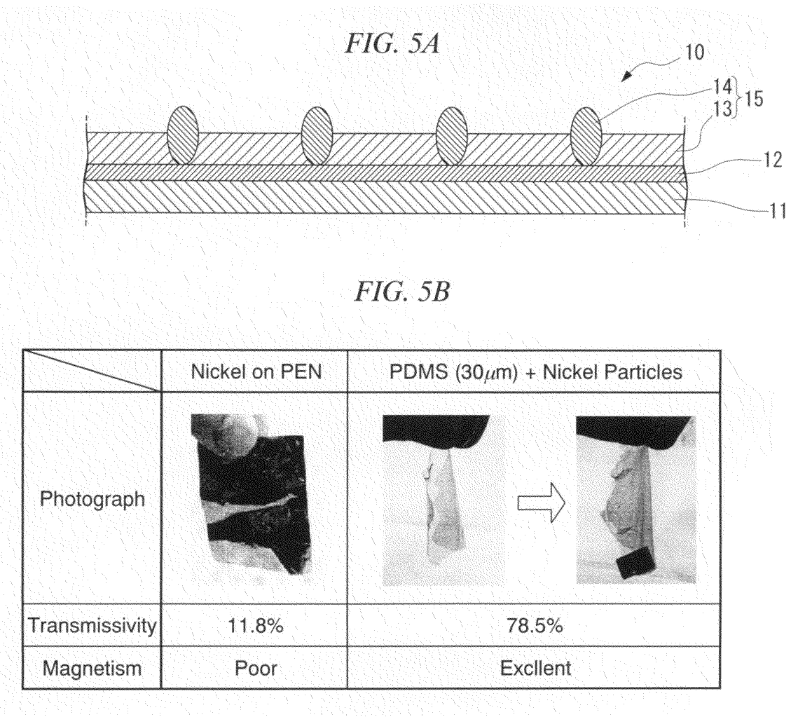

In the display device 10 of the present invention, in order to realize the above-described effects, as shown in FIG. 5A, as the transparent movable electrode 1, it is preferable to use a conductive magnetic film comprising a transparent insulator layer 11, a transparent conductor layer 12, and a transparent magnetic layer 15 formed by transparent elastic material 13 in which granular magnetic material 14 is dispersed, arranged in a stack. The transparent insulator layer 11 is preferably a transparent resin that has high durability and insulates the transparent fixed electrode 3 from the transparent movable electrode 1, and from the points of view of excellent durability and excellent insulating properties, it is possible to use a transparent resin film such as polyethylene naphthalate (PEN), polyethylene terephthalate (PET), or polytetrafluoroethylene. The transparent insulator layer 11 needs a certain degree of thickness in order to ensure the durability strength to insulate the transparent fixed electrode 3 and the transparent movable electrode 1. However, it is preferable to use a thin one in order to have stable operation using a small driving voltage of the display device 100. In the case where polyethylene naphthalate (PEN) is used, the thickness of the transparent insulator layer 11 is preferably 0.5 to 5 μm, and is more preferably 1 to 3 μm. It is possible to use indium oxide-stannic oxide (ITO) thin film as the transparent conductor layer 12. Furthermore, the transparent magnetic layer 15 can be formed by dispersing nickel particles in the transparent elastic material 13 formed from polydimethylsiloxane (PDMS). The average particle diameter of the nickel particles is preferably in a range of 5 to 100 μm, and is more preferably in a range of 10 to 50 μm. Moreover, it is preferable to form the transparent magnetic layer 15 by dispersing nickel particles and glass particles as scattering sources in the transparent elastic material 13 formed from polydimethylsiloxane (PDMS).

It is possible to make a transparent magnetic film having transparency, which does not have a mirror structure such as a conventional magnetic film, by dispersing and mixing particles of a magnetic substance in a transparent film. This transparent magnetic film 10 can be used as the transparent movable electrode 1 of the display device 100 of the present invention. The transparent magnetic film 10 has a magnetic force greatly exceeding the conventional mirror type, and can be made into a film that can have a magnet dragged over it.

The transparent insulator layer 11, the transparent conductor layer 12, and the transparent magnetic layer 15 may be stacked in any order. However, in order to be operated stably using a small driving voltage, when the transparent fixed electrode 3 and the transparent movable electrode 1 make insulated contact with each other, it is preferable that the distance between the two conductive material layers is small. Therefore, in the case of employing a conductive magnetic film that is made by stacking the transparent insulator layer 11, the transparent conductor layer 12, and the transparent magnetic layer 15, as the transparent movable electrode 1, it is preferable that a construction is used, as shown in FIG. 5A, in which the transparent conductor layer 12 is stacked on the transparent insulator layer 11, and furthermore the transparent magnetic layer 15 is stacked on the transparent conductor layer 12, so that the transparent magnetic layer 15 is disposed on the opposite side to the transparent fixed electrode 3, and the transparent fixed electrode 3 and the transparent movable electrode 1 make contact via the transparent insulator layer 11.

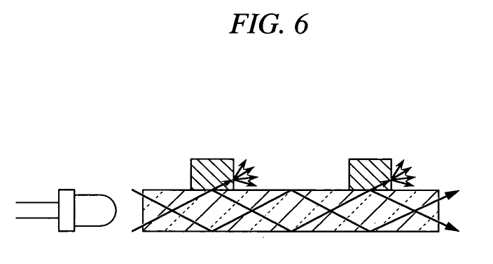

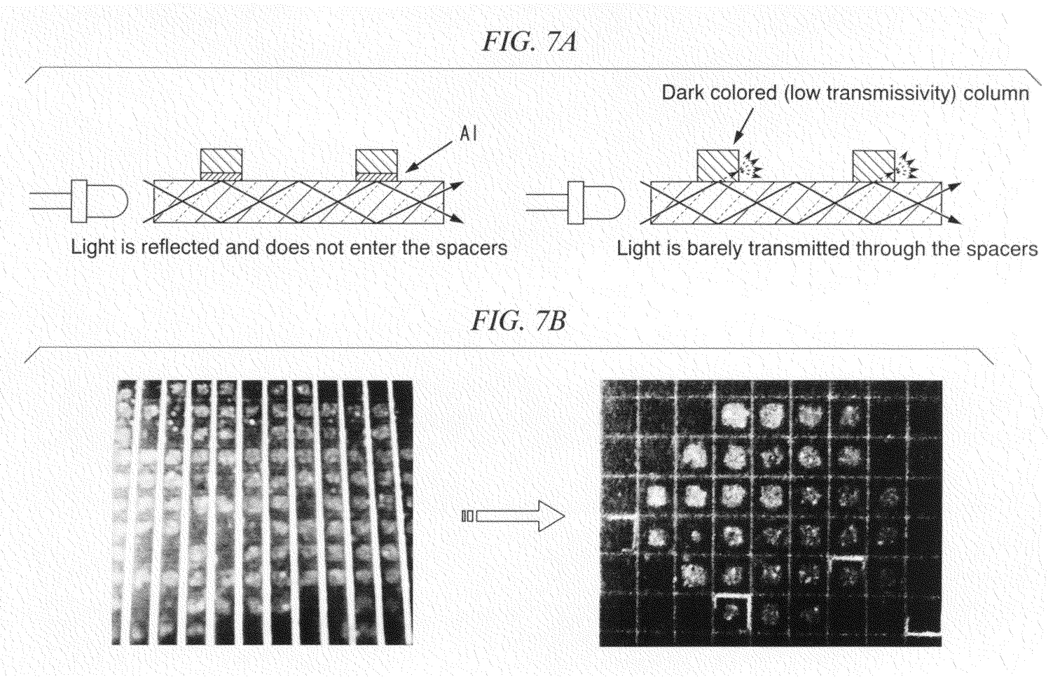

In the display device 100 of the present invention (FIG. 1A), it is preferable to have spacers 4 disposed between the transparent movable electrode 1 and the transparent fixed electrode 3. In this case, if transparent material is used for the spacers 4, they shine brightly (FIG. 6 and left hand side of FIG. 7B). On the other hand, if a metallic color or dark colored (low transmissivity) material is used and sandwiched between the transparent fixed electrode 3 as shown on the left hand side of FIG. 7A, light is reflected and does not enter the spacers 4, so that the light is prevented from scattering in the spacers 4 (right hand side of FIG. 7B). Furthermore, as shown on the right hand side of FIG. 7A, even if a dark colored (low transmissivity) material is used as the spacers 4, light is barely transmitted through the spacers 4, and hence light scattering in the spacers 4 can be prevented. In the display device 100 having an optical waveguide type display structure, by preventing light scattering in the spacers 4, the brightness of the pixels can be improved. The spacers 4 may be wall-shaped, or may be columnar. Moreover, the pixels formed by the spacers 4 may be a grid comprising a large number of squares, or may be a combination of hexagons, circles and polygons.

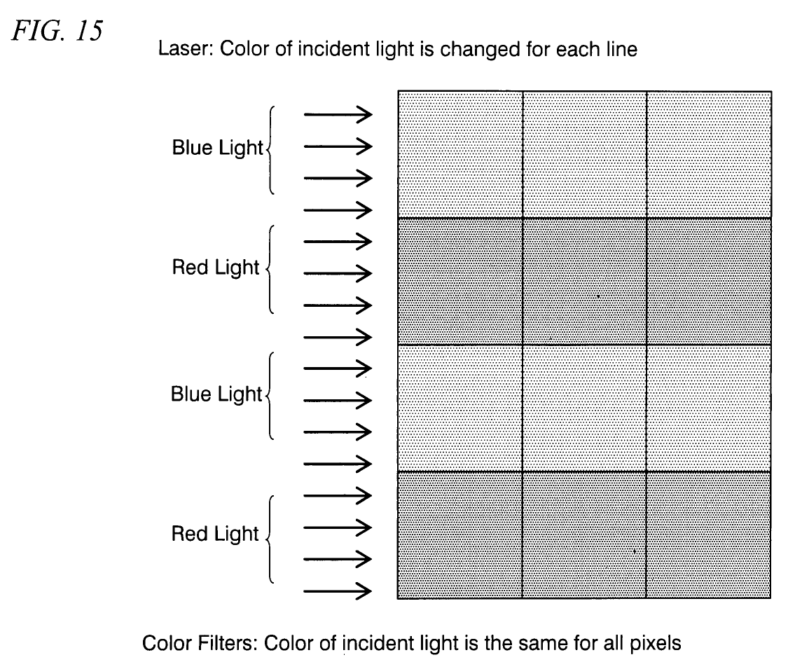

In the display device 100 of the present invention, color handling is possible. The pixels are arranged such that they have different colors such as red pixels and blue pixels. For this, a color filter or a parallel laser beam is used. By pushing the pixels apart, it is possible for them to take on a color. For example, as shown in FIG. 15, the color of the incident laser beam is changed by line, for a blue line, a red line, or the like. Depending on the laser beam, it is also possible to make a green line. On the other hand, the incident light can be made the same (white) for all pixels, and color filters of a plurality of colors can be used, so that it is also possible to arrange to have different colors such as cyan colored pixels, magenta colored pixels and yellow colored pixels.

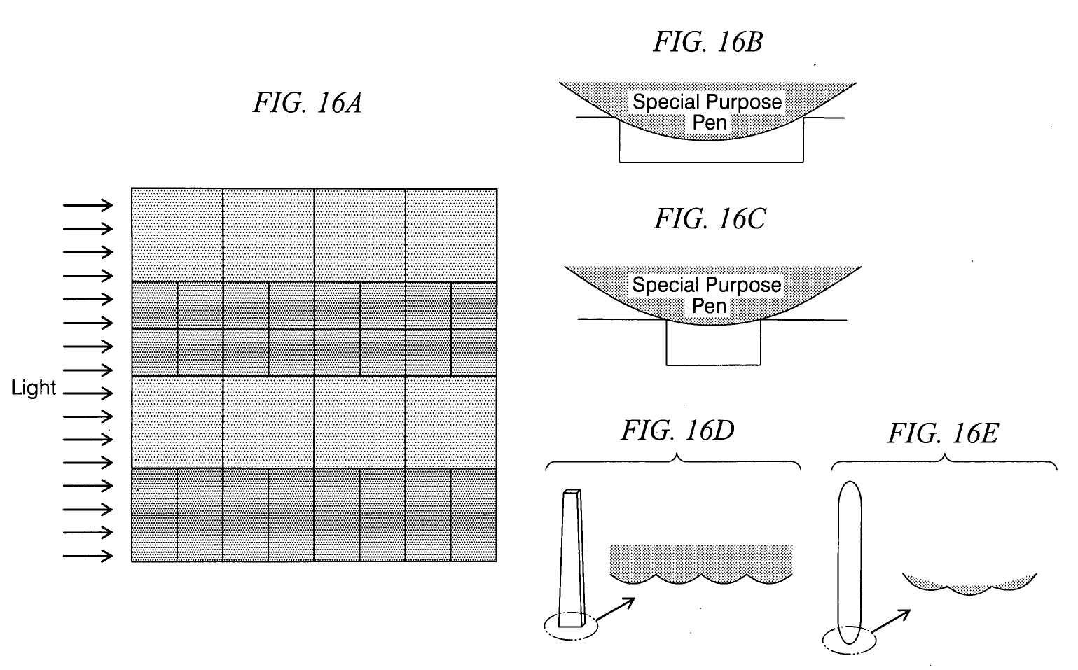

In the display device 100 of the present invention, in order to realize colorization, for example, as shown in FIG. 16, the pixel sizes can be altered to configure them for different colors, such that large pixels are blue, small pixels are red, and so on, and the colors that the pixels emit are changed by color filters or a laser beam. They are pressed by a comparatively hard, special-purpose pen whose pen tip is spherical.

When pressed by the special-purpose pen, it is possible to apply a large displacement only to the film (transparent movable electrode 1) of large pixels, so that only large pixels can be turned to the on (bright) state of a blue color, selectively. Furthermore, when pressed by a soft pen point such as a finger, all pixels can be turned to the on (bright) state of a blue color or a red color. That is, it is possible to control the display color by the radius of curvature. In FIG. 16A, a white light is radiated, and color filters of a cyan color and a magenta color are used. However, it is also possible to use a laser beam to select any combination from one color of blue, red, green, and the like, to three colors or more, it is also possible to use color filters to select any combination from one color of a cyan color, a magenta color, a yellow color, and the like, to three colors or more, and it is also possible to select any combination of these colors and sizes of pixels as required.

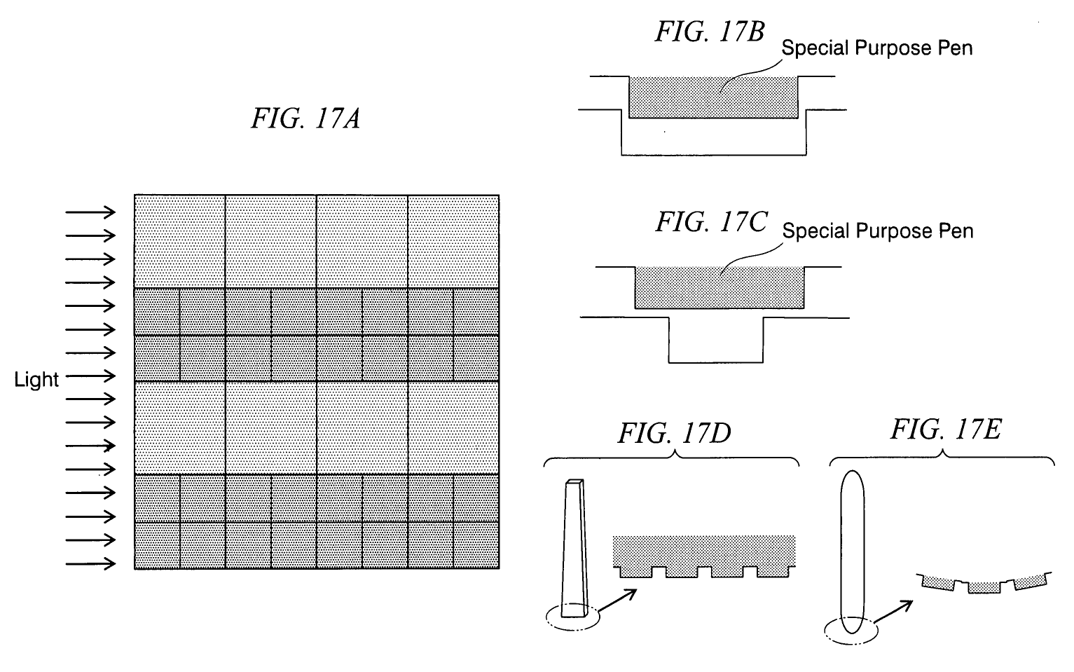

In the display device 100 of the present invention, in order to realize the colorization, for example, as in FIG. 17, the pixel sizes can be altered to configure them for different colors, and the colors that the pixels emit are changed by color filters or a laser beam. They are pressed by a comparatively hard, special-purpose pen whose pen point has a square shape. In the case where they are pressed by this special-purpose pen also, it is possible to apply a large displacement only to the film (transparent movable electrode 1) of large pixels, so that only large pixels can be turned to the on (bright) state of a blue color, selectively. In this case also, when pressed by a soft pen point such as a finger, all pixels can be turned to the on (bright) state of a blue color or a red color. In FIG. 17A, a white light is radiated, and color filters of a cyan color and a magenta color are used. However, it is also possible to use a laser beam to select any combination from one color of blue, red, green, and the like, to three colors or more, it is also possible to use color filters to select any combination from one color of a cyan color, a magenta color, a yellow color, and the like, to three colors or more, and it is also possible to select any combination of these colors and sizes of pixels as required.

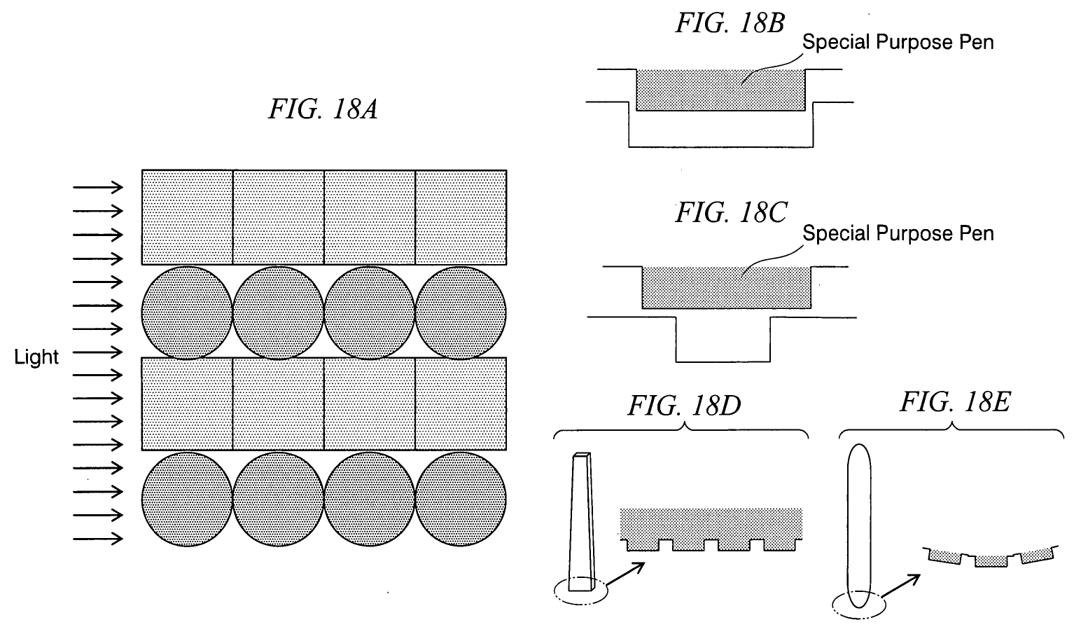

In the display device 100 of the present invention, in order to realize the color handling, for example, as in FIG. 18, the pixel shapes can be altered to configure them for different colors, and the colors that the pixels emit are changed by color filters or a laser beam. They are pressed by a comparatively hard, special-purpose pen whose pen point has a square shape. In the case where they are pressed by this special-purpose pen, it is possible to apply a large displacement only to the film (transparent movable electrode 1) of square-shaped pixels, so that only square-shaped pixels can be turned to the on (bright) state of a blue color, selectively. In this case also, when pressed by a soft pen point such as a finger, all pixels can be turned to the on (bright) state of a blue color or a red color. In FIG. 18A, a white light is radiated, and color filters of a cyan color and a magenta color are used. However, it is also possible to use a laser beam to select any combination from one color of blue, red, green, and the like, to three colors or more, it is also possible to use color filters to select any combination from one color of a cyan color, a magenta color, a yellow color and the like, to three colors or more, and it is also possible to select any combination of these colors and shapes of pixels as required.

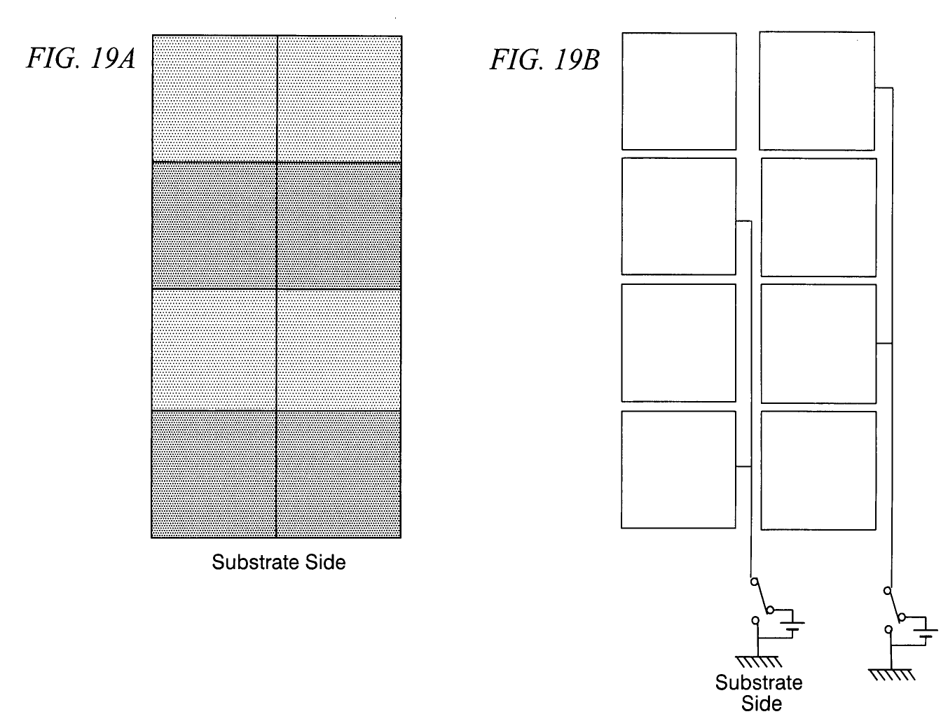

In the display device 100 of the present invention, in order to realize the color handling, for example, as in FIG. 19, a method can be employed in which wiring is laid out in the longitudinal direction on the substrate (transparent fixed electrode 3) side, and switches are installed in the lower part of a blackboard. For example, as in FIG. 19A, if eight pixels are to be configured as a blue color, a red color, a blue color, and a red color from the top, a power supply switch (right hand side of FIG. 19B), which applies a driving voltage to the pixels corresponding to the blue color, and a power supply switch (left hand side of FIG. 19B), which applies a driving voltage to the pixels corresponding to the red color, are provided separately, and the switch that corresponds to the color of the parts of the blackboard that are to be drawn on is turned on. It is also possible to use a laser beam to select any combination from one of a blue color, a red color, a green color, and the like, to three or more, it is also possible to use color filters to select any combination from one color of a cyan color, a magenta color, a yellow color and the like, to three colors or more, and it is also possible to select any combination of pixel locations of these colors as required.

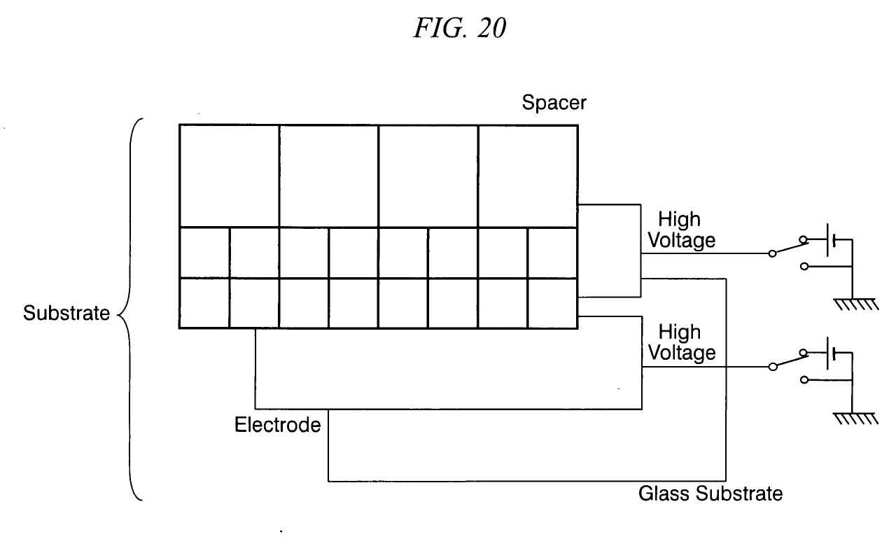

In the display device 100 of the present invention, in order to realize the color handling, for example, as in FIG. 20, the transparent fixed electrode 3 on the substrate side (spacers 4, transparent fixed electrode 3, and the glass substrate forming the optical waveguide 2) is divided into sections, and by setting the transparent fixed electrodes 3 corresponding to the spacers 4 that form large pixels to a low voltage, and by setting the transparent fixed electrodes 3 corresponding to the spacers 4 that form small pixels to a high voltage, it is possible to ensure a similar level of operability in the pixels of each size. Simple wiring is laid out on the substrate side, and control is achieved by changing the voltage applied to the pixels of the red part, and the voltage of the blue part.

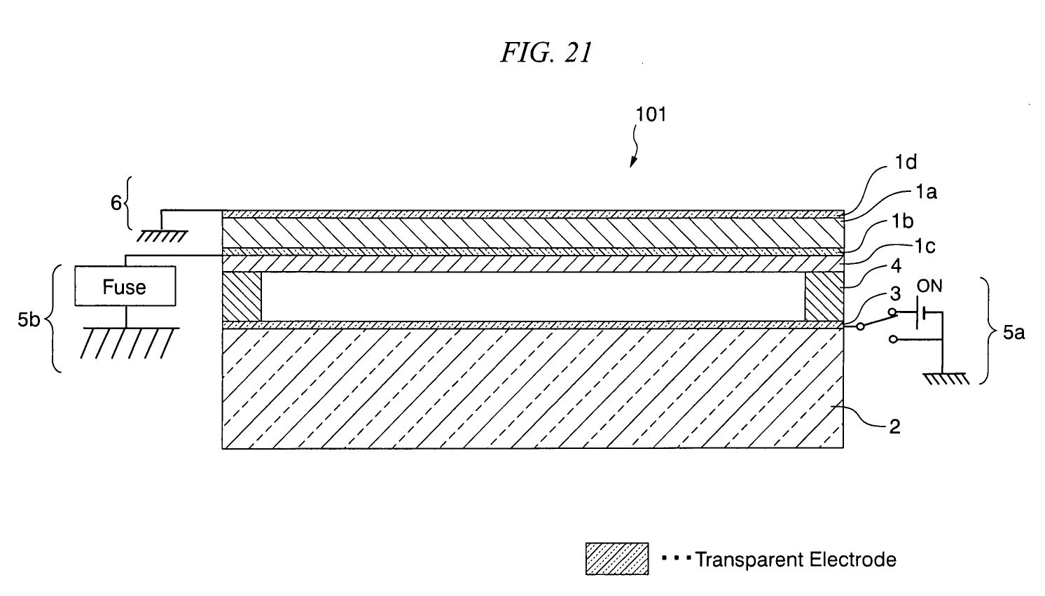

In the display device 100 of the present invention, in order to realize a measure for preventing electric shocks to the fingers, the thin film (transparent movable electrode 1) side is always grounded. However, as in a display device 101 of FIG. 21, it is considered to laminate a transparent conductor layer 1d on the top of the transparent magnetic layer 1a of the transparent movable electrode 1, and ground both the transparent conductor layer 1b and the transparent conductor layer 1d, to thereby produce an effect of further preventing electric shocks. Here, the transparent movable electrode 1 is formed by the transparent magnetic film 10 comprising; a transparent insulator layer 1c, the transparent conductor layer 1b, the transparent magnetic layer 1a, and the transparent conductor layer 1d. Moreover, it is more preferable that the construction is such that the transparent conductor layer 1b on the inner side of the transparent movable electrode 1 is grounded via a fuse, and the circuit is turned off when current is generated due to a short-circuit between the film (transparent movable electrode 1) and the substrate (transparent fixed electrode 3).

In the display device 100 of the present invention, in order to realize a measure for improving the durability of the transparent movable electrode 1, a durability protecting film 7 is further laminated on the transparent magnetic film 10, being the transparent movable electrode 1, and by pressing on the durability protecting film 7 instead of pressing on the transparent magnetic film 10 directly, it is possible to improve the durability of the transparent movable electrode 1. The durability protecting film 7 also produces an effect of preventing electric shocks to the fingers at the same time.

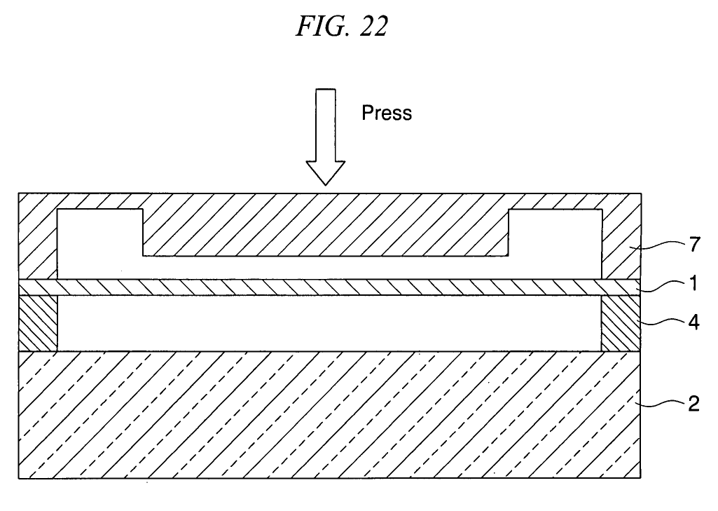

Here, by making the parts of the durability protecting film 7 that correspond to the spacers protruding, and the parts that correspond to the centers of the pixels recessed, for stacking, it is possible to improve the reliability of operation. Furthermore, as shown in FIG. 22, by making the parts of the durability protecting film 7 that correspond to the spacers protruding, and the parts that correspond to the centers of the pixels recessed, and performing a process to provide a protruding part in almost the center of the recessed part corresponding to the center of the pixel, it is possible to have a measure for preventing electric shocks to the fingers, a measure for improving the durability of the transparent movable electrode 1, and a measure for improving the reliability of operation.

In this manner, in the display device 100 of the present invention, it is possible to realize a blackboard type device that attracts a pair of electrode plates by electrostatic force, and retains colors. When a constant voltage is applied to a capacitor, the capacitor has two stable states. One is a state in which the pair of electrode plates are apart, and the other is a state in which the pair of electrode plates are held in contact with each other while retaining electrical insulation. It is possible to propose a device whose states can be changed by external force, and that can display colors, with the voltage remaining constant.

In this manner, in the display device 100 of the present invention, it is possible to propose a blackboard type device whose retained colors can be erased instantly and simultaneously by removing the voltage using one button.

In the display device 100 of the present invention, it is possible to use a transparent magnetic film 10 as one electrode plate. Since the transparent magnetic film 10 has appropriate resolution, and also contains silicone rubber mixed with particles of magnetic material, it realizes a strong magnetic force that cannot be produced by a conventional magnetic film, and high transmissivity (transparency). By using the transparent magnetic film 10, it is possible to partially return to an original stable point by pulling the electrode plate (film) by a magnet after retaining color. That is, it is possible to propose a blackboard type device whose colors can be partially erased by a magnet.

In the display device 100 of the present invention, these structures can be easily constructed by a stacking process that has thin wire parts on a scale of greater than or equal to 20 μm, so that it is possible to propose a blackboard type device that is compatible with large area production methods such as current printing techniques or the like.

In the display device 100 of the present invention, by adopting the structures described above, it is possible to propose a blackboard type device that does not require a complicated wiring layout or processing in a central processing unit (CPU), as does a touch panel, and does not require display on a liquid crystal device or the like on the other side, or display on a display device separated from an input device.

Hereunder is a further detailed description of embodiments of the present invention.

### Embodiment 1

(Transparent Magnetic Film 10)

A PEN film (2 μm in thickness) was used for the material of the transparent insulator layer 11, and an ITO film with a thickness of 20 nm was coated on it. A mixed liquid made of PDMS liquid (100 parts by weight, SILPOT 184 W/C made by Toray Co. Ltd.), its hardening agent (10 parts by weight), and nickel particles (100 parts by weight, average particle diameter approximately 20 μm, maximum particle diameter 50 μm), was prepared. The mixed liquid was used to produce a film on the ITO film using a spin coater (room temperature, 3000 rpm, 30 s), and hardened at 95° C. for 10 minutes. As a result, as in FIG. 5A, a transparent magnetic film 10 was obtained, which was formed by a transparent insulator layer 11 (PEN layer), a transparent conductor layer 12 (ITO layer), and a transparent magnetic layer 15 formed from a transparent elastic material 13 (PDMS) in which granular magnetic material 14 (nickel particles) was dispersed, arranged in a stack. The thickness of the transparent PDMS layer was approximately 30 μm. The nickel particles were dispersed approximately evenly in the PDMS in a state in which the top parts stood out on the surface of the transparent magnetic film 10. By so doing, the transparent magnetic film 10 could have excellent transparency, strong magnetism to hold a magnet, and excellent electrical conduction properties.

Of these, the characteristics of the “PDMS+nickel particle” transparent magnetic layer 15 are described using FIG. 5B. For comparison, a magnetic film as shown on the left hand side of FIG. 5B was prepared. This magnetic film was formed by a PEN film 11 (9 μm thick) on which a nickel layer 16 with a thickness of 15 nm was laminated. This magnetic film had an extremely weak force for attracting magnets, and the boundary with the nickel layer became a mirror surface, so that satisfactory transparency could not be obtained (transmissivity 11.8%). On the other hand, regarding the transparent magnetic film 10 of FIG. 5A, the magnetic film from which the “PDMS+nickel particle” layer was peeled off, had both excellent transparency (transmissivity 78.5%), and such strong magnetism that it could lift a magnet.

### Embodiment 2

(Display Device 100)

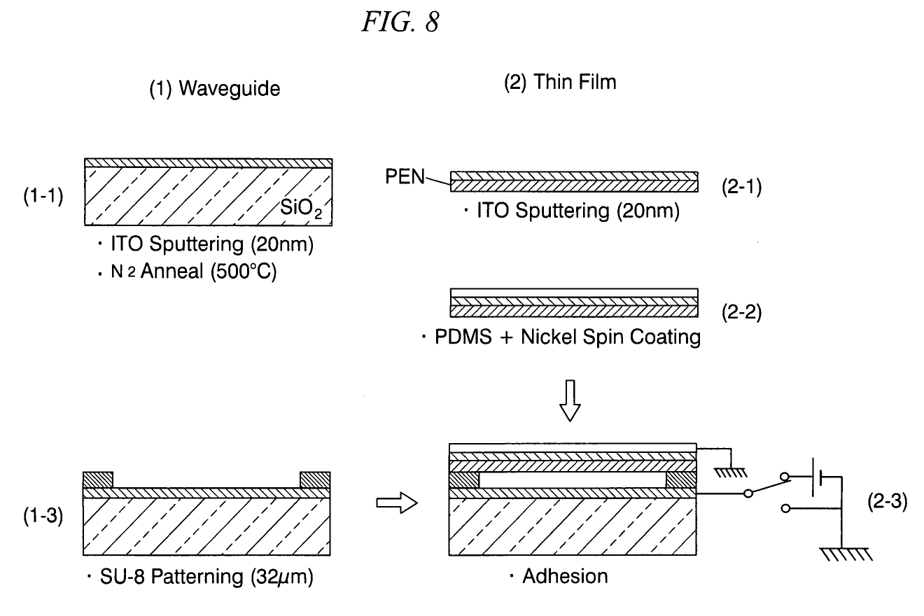

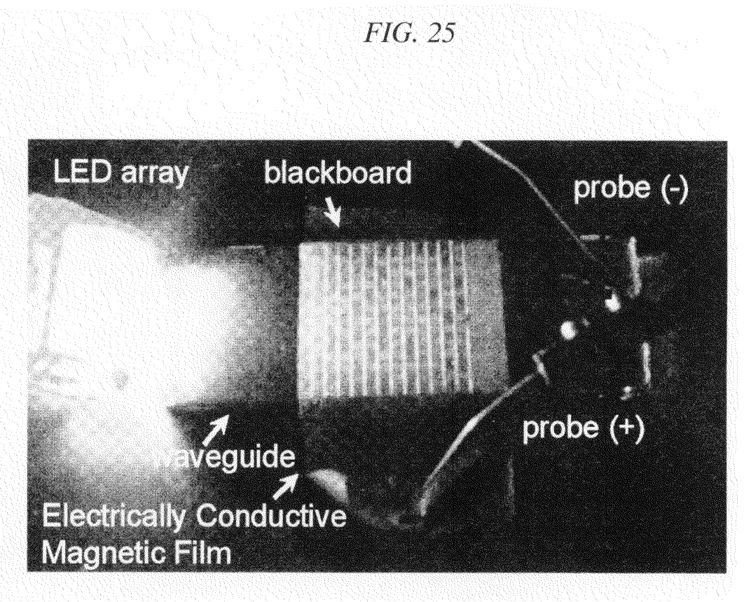

The manufacturing process of the display device 100 of the present invention according to embodiment 2 is shown in FIG. 8. An optical waveguide 2 was formed from only a transparent material. ITO with a thickness of 20 nm was laminated on the SiO₂ optical waveguide substrate by sputtering. ITO with better transparency was obtained by holding it at 500° C. in an N₂ atmosphere. Spacers 4 with a width of 20 μm, a height of 24 μm, in 2 mm squares, were formed using SU-8. As in FIG. 8, by adhering the transparent magnetic film 10 obtained in embodiment 1 such that the spacers 4 in 2 mm squares had an insulator layer on their tops, forming 2 mm square pixels, the display device 100 according to embodiment 2 of the present invention was obtained. FIG. 25 shows the setup of the display device 100. An LED was used for the transmitted light, and the experiment was performed in a darkroom.

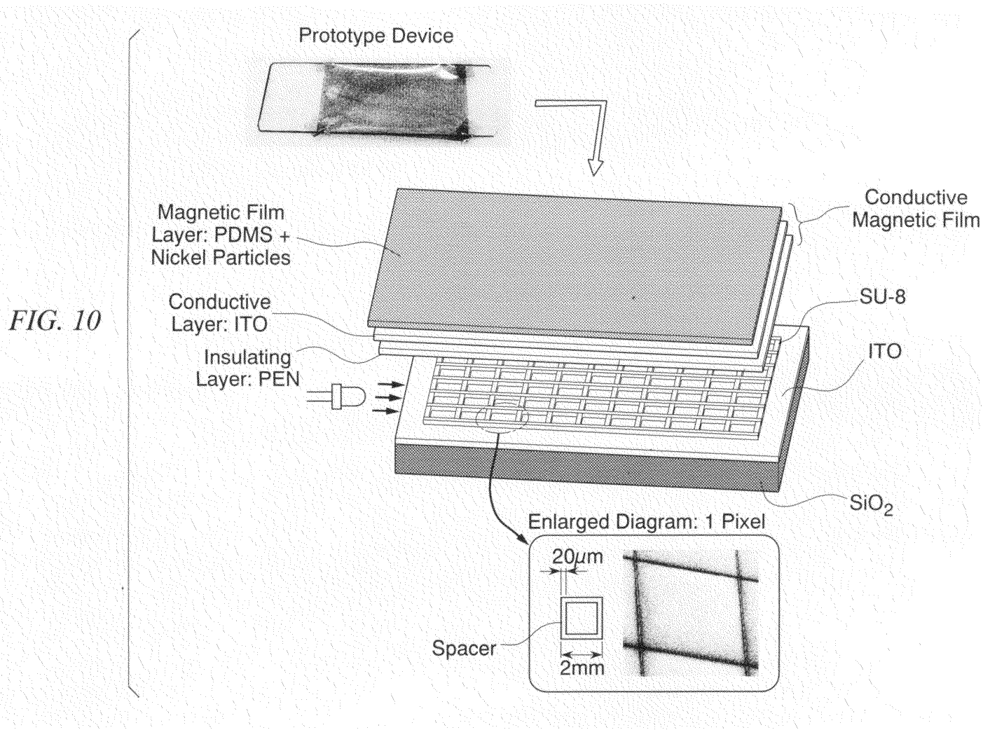

The left hand side of FIG. 10 is a schematic diagram showing a display device 100 according to embodiment 2 of the present invention. This display device 100 comprises an SiO₂ optical waveguide 2, a transparent movable electrode 1 formed from a conductive transparent magnetic film 10 with a layered structure, a transparent fixed electrode 3, and wall-shaped spacers 4 that form 2 mm square pixels on the optical waveguide 2. The spacers 4 are made from photoresist (SU-8). The width of the wall-shaped spacers 4 is 20 μm, and the height is 24 μm. On either one of the movable electrode side or the fixed electrode side, the electrodes are not patterned. The transparent magnetic film 10 is formed by a “PDMS+nickel particle” layer, an ITO layer (conductive layer), and a PEN layer. Since it has a “PDMS+nickel particle” magnetic film layer, it can be dragged over by a magnet. The ITO layer has a function as an electrode, and the PEN layer (insulating layer) insulates the movable electrode 1 and the fixed electrode 3, and also has an effect of increasing its strength. An enlarged photo of a pixel is shown at the bottom right.

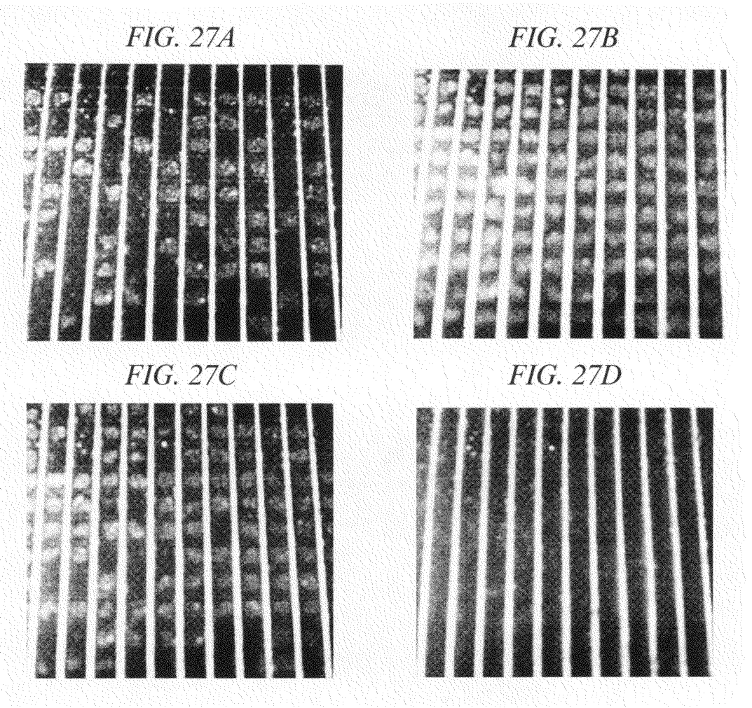

FIG. 27A to FIG. 27D show the operation of the display device 100 of the present invention. A 92 V DC voltage was applied to each of the 2 mm square pixels. The releasing voltage (V_{releasing}) and pull-in voltage (Vₚᵤₗₗ₋ᵢₙ) are shown in Table 1. It is considered that the reason for the difference in voltage between pixels as shown in Table 1 is that there was a great dispersion in the height of the spacers 4.

TABLE 1

| | V_{releasing} | Vₚᵤₗₗ₋ᵢₙ |
|---|---|---|
| Minimum | 28 V | 62 V |
| Maximum | 64 V | 138 V |

The driving voltage was set to 92 V in order to maintain the strength of the contact between the pair of electrodes to a certain extent. As shown in Table 1, this is a value greater than or equal to the pull-in voltage for some pixels. Therefore, as shown in FIG. 27A, almost half of the pixels were automatically turned to the on (bright) state by the driving voltage. In FIG. 27A, the pixels in the black parts are pixels that are operating normally.

FIG. 27B is a photograph showing a state of writing by pressing with a finger.

FIG. 27C is a photograph showing a state in which the movable electrode 1 is partially pulled outwards by tracing a magnet over it for erasing. Among the pixels that were normal pixels in FIG. 27A, some of the pixels that were pulled outwards by the magnet turned back to black. This means a partial erase. Some of the normal pixels were not traced over by a magnet, so they maintain the on (bright) state by the driving voltage. That is, in the display device 100 according to embodiment 2, in which the transparent magnetic film 10 according to embodiment 1 is used for the transparent movable electrode 1, it was possible to restore the transparent movable electrode from the aforementioned second stable state to the first stable state by external magnetic force, and the input image could be partially erased.

On the other hand, all pixels were turned to the off (dark) state (FIG. 27D) by turning the driving voltage off. This means a simultaneous erase in this electronic blackboard. That is, in the display device 100 according to embodiment 2, in which the transparent magnetic film 10 according to embodiment 1 is used for the transparent movable electrode 1, it was possible to restore the transparent movable electrode to the aforementioned first stable state by removing the driving voltage, and the input image could be simultaneously erased.

### Embodiment 3

(Display Device 100)

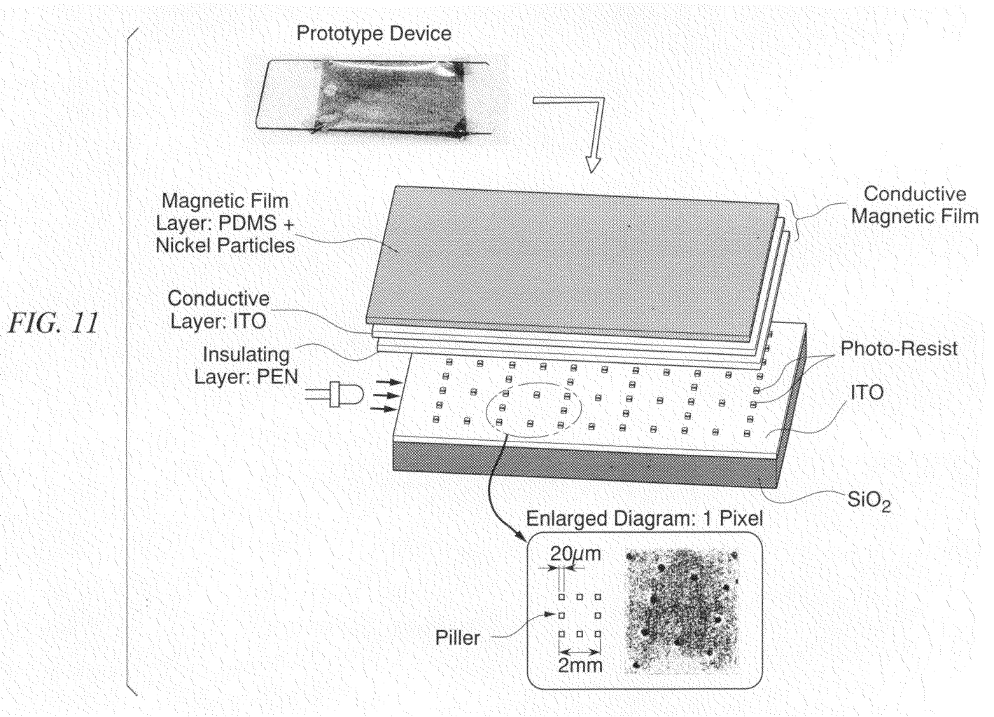

FIG. 11 is a schematic diagram showing a display device 100 according to embodiment 3 of the present invention. The spacers 4 of the display device 100 are columnar, and form 1 mm square pixels, lattice-like. The other structures are the same as in the case of the display device 100 of embodiment 2.

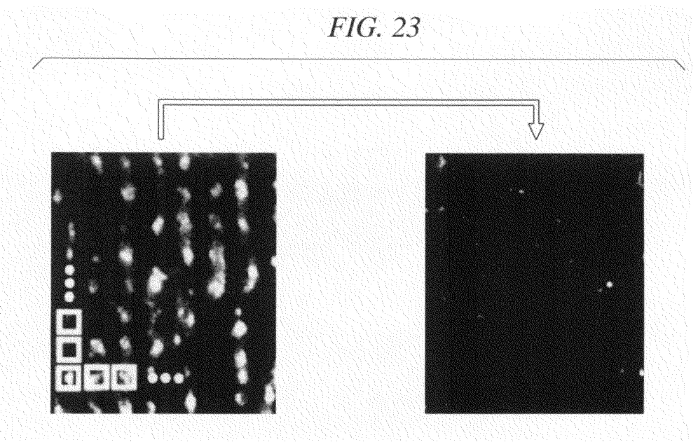

FIG. 23 shows photographs of an example of simultaneous erasing in the display device 100 according to embodiment 3. Here, pull-in was performed by pressing using a glass stylus (white part on the left hand side of FIG. 23). Those pixels were simultaneously erased by removing the voltage (right hand side of FIG. 23).

### Embodiment 4

(Display Device 100)

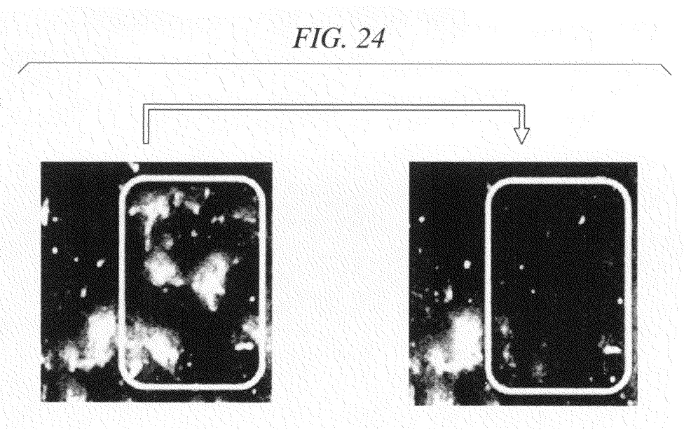

A display device 100 of the present invention according to embodiment 4 was manufactured similarly to embodiment 3, except that in embodiment 3, the spacers 4 were columnar and formed 2 mm square lattice-like pixels. FIG. 24 shows photographs of an example of partial erase in the display device 100. Here, a 150 V DC voltage was applied to the 2 mm square pixels. However, by tracing over them using a magnet, the pixels were turned to the off (dark) state (black part in the white frame on the right hand side of FIG. 24). The parts that were not pulled out remained in contact by the applied voltage and maintained the on (bright) state.

### Embodiment 5

(Transparent Magnetic Film 10)

A PEN film (2 μm in thickness) was used as the material of the transparent insulator layer 11, and an ITO film with a thickness of 20 nm was coated on it. A mixed liquid made of PDMS liquid (100 parts by weight, SILPOT 184 W/C made by Toray Co. Ltd.), its hardening agent (10 parts by weight), nickel particles (100 parts by weight, average particle diameter approximately 50 μm), and glass beads (100 parts by weight) was prepared. When the mixed liquid was used to produce a film on the ITO film by a spin coater (room temperature, 3000 rpm, 30 s), and hardened at 95° C. for 10 minutes, as in FIG. 5A, a transparent magnetic film 10 was obtained, which was formed by a transparent insulator layer 11 (PEN layer), a transparent conductor layer 12 (ITO layer), and a transparent magnetic layer 15 formed from a transparent elastic material 13 (PDMS) in which granular magnetic material 14 (nickel particles) and glass beads were dispersed, arranged in a stack. The thickness of the transparent PDMS layer was approximately 30 μm. The nickel particles were dispersed approximately evenly in the PDMS in a state in which the top parts stood out on the surface of the transparent magnetic film 10.

### Embodiment 6

(Display Device 100)

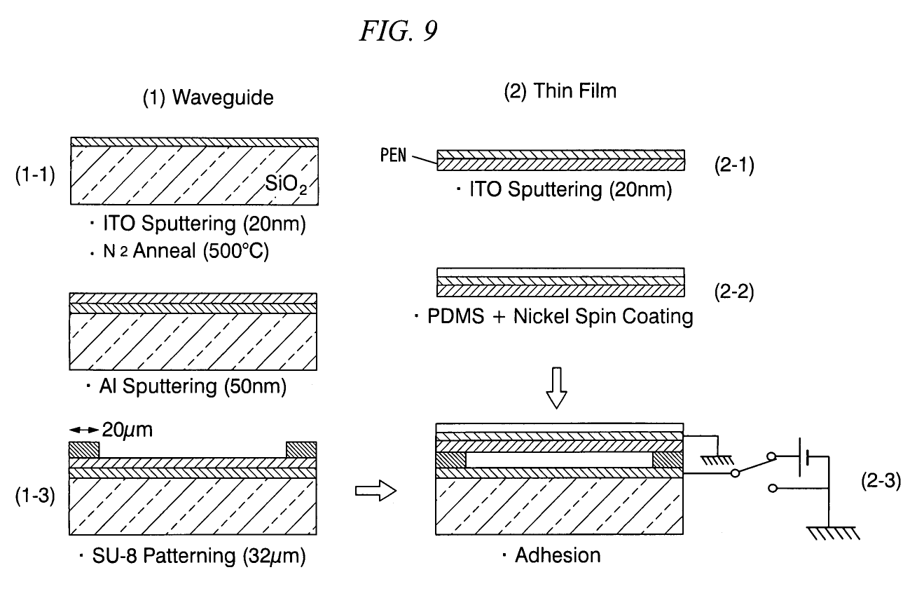

A manufacturing process of a display device 100 of the present invention according to embodiment 6 is shown in FIG. 9. The optical waveguide 2 was formed from only a transparent material. ITO with a thickness of 20 nm was laminated on the SiO₂ optical waveguide substrate by sputtering. ITO with better transparency was obtained by holding it at 500° C. in an N₂ atmosphere. A sputtered Al layer (50 nm) was formed on the ITO film. Furthermore, spacers 4 with a width of 20 μm, a height of 24 μm, in 2 mm squares, were formed on the sputtered Al layer using SU-8 by patterning. As in FIG. 9, by adhering the transparent magnetic film 10 obtained in embodiment 5 such that the spacers 4 in 2 mm squares had an insulator layer on their tops, forming 2 mm square pixels, the display device 100 according to embodiment 6 of the present invention was obtained. Moreover, for preventing electric shocks to the fingers, the transparent movable electrode side was always grounded.

Regarding this display device 100, when the releasing voltage (V_{releasing}) and pull-in voltage (Vₚᵤₗₗ₋ᵢₙ) were obtained from the hysteresis behavior of the applied voltage—transparent movable electrode displacement, the releasing voltage (V_{releasing}) was 70 V, and the pull-in voltage (Vₚᵤₗₗ₋ᵢₙ) was 140 V. Furthermore, it was possible to confirm that the values of the releasing voltage (V_{releasing}) and the pull-in voltage (Vₚᵤₗₗ₋ᵢₙ), measured by increasing and decreasing the DC voltage manually, are repeatable, even in the case where they were measured using Neoark Corporation optical heterodyne micro vibration measuring equipment, and it was also possible to confirm that there is little dispersion between pixels. Therefore, the driving voltage was set to 110 V.

Moreover, the erase time of the display device 100 was measured. In order for the display device 100 to be switched from the on (bright) state to the off (dark) state, it is sufficient if the transparent movable electrode is separated by 10 μm from the contact position of the pair of electrodes. However, the time required for the transparent movable electrode to move 10 μm away from the contact position after the driving voltage was turned off was 30 ms. It was proved that letters and images could be erased in milliseconds.

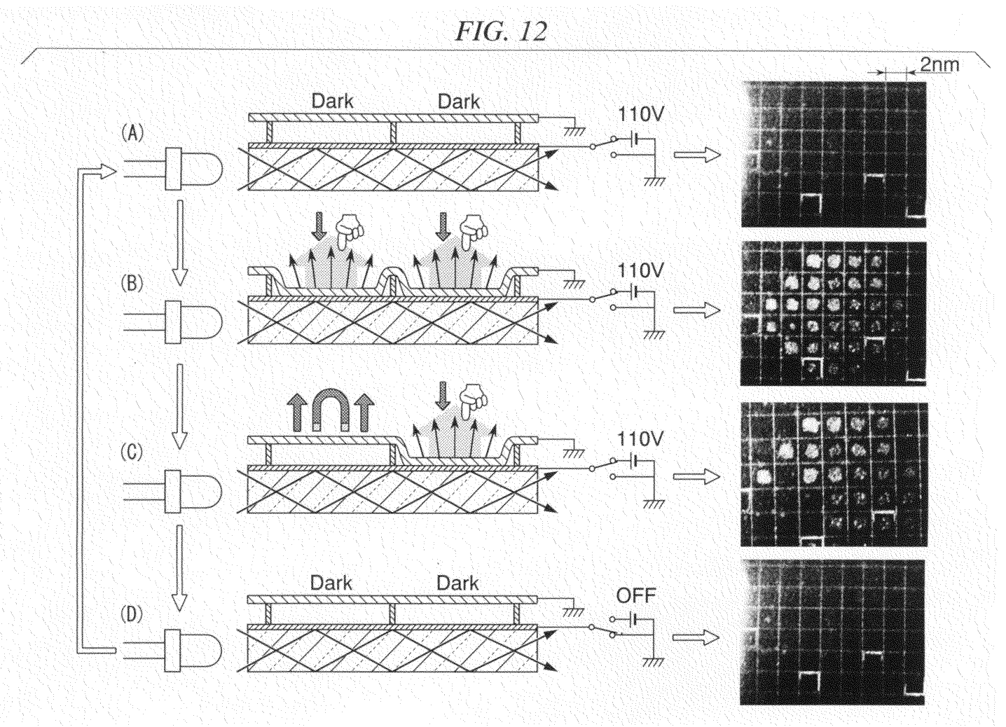

FIG. 12 shows the operation of the display device 100 of the present invention according to embodiment 6. Since metallic coloring treatment is performed on the transparent fixed electrode side of the spacers 4, light scattering in the spacers 4 is decreased, so that excellent contrast can be obtained overall. In FIG. 12, (A) shows the initial state. All pixels are in the off (dark) state. In FIG. 12, (B) shows the state of writing. The pixels that were pressed by a fingertip are in the on (bright) state, and are shown as circles. In FIG. 12, (C) shows a partial erase. An area on the left hand side, which was traced over by a magnet, is changed to the off (dark) state from the on (bright) state. In FIG. 12, (D) shows a full simultaneous erase. All pixels are in the off (dark) state, and returned to the initial state.

All operations of writing, partial erase and simultaneous erase were realized.

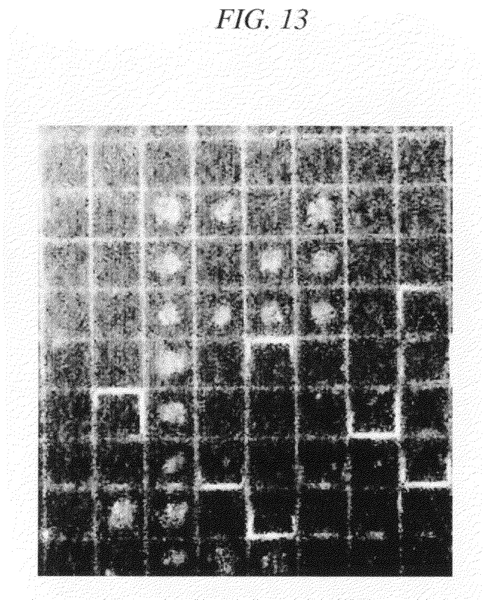

As shown in FIG. 13, by using the display device 100 of the present invention according to embodiment 6, a letter “P” was written successfully.

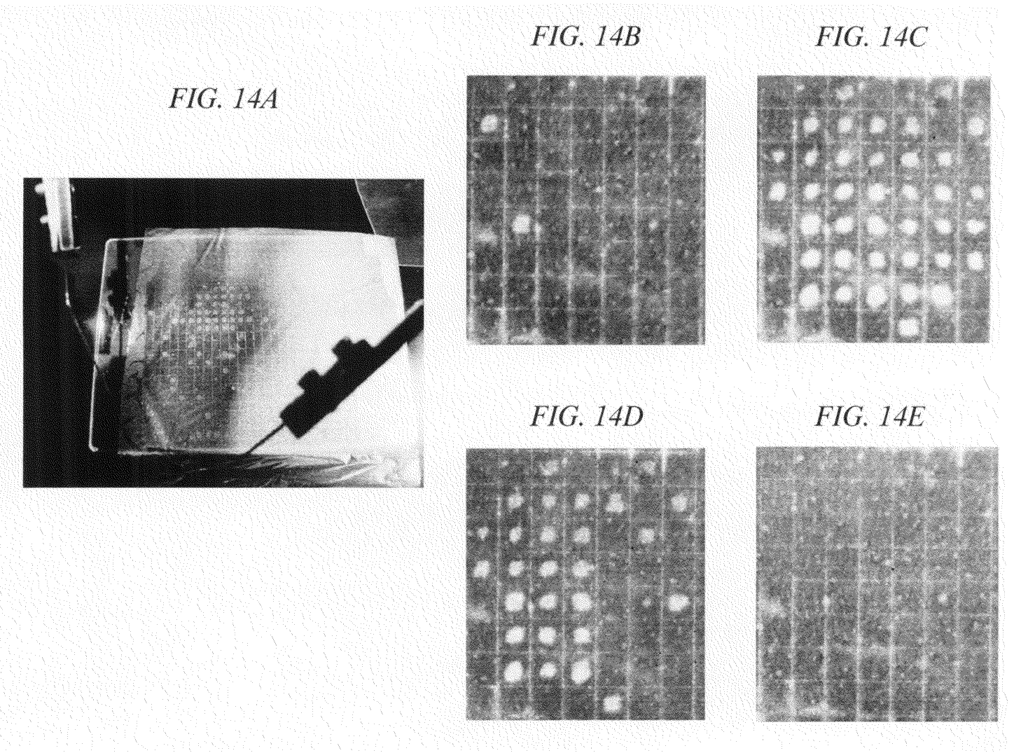

FIG. 14 shows photographs taken in a bright room when the operations of the initial state (B), writing (C), partial erase (D), and simultaneous erase (E) were performed on the display device 100 (A) of the present invention according to embodiment 6. Since glass particles are dispersed as scattering sources in the transparent magnetic layer 15 of a transparent magnetic film 10 used as a transparent movable electrode 1, it is clear that a display device was obtained with excellent visibility even in a bright room.

From the display device 100 of the present invention, it is possible to propose a new type of rewritable electronic blackboard. In this electronic blackboard, it is possible to retain tracks traced by a finger electrostatically. Images drawn on the electronic blackboard can be erased partially by tracing over them with a magnet, and can be erased in totality by removing the voltage.

### INDUSTRIAL APPLICABILITY

Since the display device 100 of the present invention does not have a complicated structure, and can be manufactured using a simple structure, it can be produced easily by a stacking process having thin wire parts of a width of greater than or equal to 20 μm. Moreover the structure can be easily designed such that it is compatible with: large area printing techniques in the order of meters, such as roll to roll printing, ink jet printing, silk screen printing and offset printing; and plastic molding techniques, stamping techniques, and the like. Since large area MEMS techniques are already in practical use, it can be expected that a MEMS technique comprising a large area printing technique, a plastic molding technique, a stamping technique, and the like, could be applied to the present invention, and be used as a new electronic blackboard to substitute for widely used blackboards. It has a possibility of revolutionizing the world blackboard market, and its industrial utility value is extremely high.

1. A display device comprising:
an optical waveguide,
a transparent fixed electrode disposed in surface contact with the optical waveguide, and
a transparent movable electrode disposed facing the transparent fixed electrode on a side opposite to the optical waveguide, wherein
when a driving voltage is applied, the transparent movable electrode has a first stable state in which it is kept apart from the transparent fixed electrode by elasticity, and a second stable state in which it makes insulated contact with the transparent fixed electrode by electrostatic force, and can change from said first stable state to said second stable state by external force.

2. A display device according to claim 1, wherein said transparent movable electrode can be restored from said second stable state to said first stable state by removing said driving voltage.

3. A display device according to claim 1, wherein said transparent movable electrode can be restored from said second stable state to said first stable state by an external magnetic force.

4. A display device according to any one of claim 1, wherein said transparent movable electrode is a conductive transparent magnetic film.

5. A display device according to claim 4, wherein said transparent magnetic film is formed by laminating in a stack a transparent insulator layer, a transparent electro-conductive layer, and a transparent magnetic layer formed from transparent elastic material in which granular magnetic material is dispersed.

6. A display device according to claim 1, wherein there is provided spacers disposed between said transparent movable electrode and said transparent fixed electrode.

7. A display device according to claim 6, wherein metallic color treatment or deep color treatment is applied to said transparent fixed electrode side of said spacers.

8. A transparent magnetic film characterized in that it comprises a transparent insulator layer, a transparent conductor layer, and a transparent magnetic layer formed from transparent elastic material in which granular magnetic material is dispersed, arranged in a stack.

9. A transparent magnetic film according to claim 8, wherein said transparent insulator layer comprises polyethylene naphthalate (PEN).

10. A transparent magnetic film according to claim 8, wherein said transparent conductor layer comprises indium oxide-stannic oxide (ITO) thin film.

11. A transparent magnetic film according to claim 8, wherein said transparent magnetic layer is formed by dispersing nickel particles in transparent elastic material formed from polydimethylsiloxane (PDMS).
